(19) United States
(12) Patent Application Publication
(10) Pub. No.: US 2011/0156988 A1
(43) Pub. Date: Jun. 30, 2011

(54) DISPLAY FOR AN IMAGE

(76) Inventor: Chris Gillard, Victoria (AU)

(21) Appl. No.: 13/061,330

(22) PCT Filed: Jul. 29, 2009
(86) PCT No.: PCT/AU2009/000962

§ 371 Date: Feb. 28, 2011

(30) Foreign Application Priority Data
Aug. 26, 2008 (AU) 2008904386

(51) Int. Cl. G09G 5/00

(52) U.S. Cl. 345/4

(57) ABSTRACT

A display for an image including: a first substrate having a cyan layer of the image thereon; a second substrate having a magenta layer of the image thereon; a third substrate having a yellow layer of the image thereon; a fourth substrate having a black layer of the image thereon; the substrate layers being aligned thereby displaying the complete image.

### FIELD OF THE INVENTION

The present invention relates to a display for images and in particular to a display for works of visual art and to methods of making them.

The invention has been developed primarily for use as a display for photographs and graphical images and will be described hereinafter with reference to this application. However, it will be appreciated that the invention is not limited to this particular field of use.

### BACKGROUND OF THE INVENTION

In this specification unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

Works of visual art are a popular means of capturing, documenting and expressing events or emotions. An artist can create a work of visual art as an expression of their creativity or feelings. People purchase and display works of visual art for many reasons including aesthetic appeal, investments and expressions of themselves.

There are a great number of visual arts including photographs, paintings, printmaking, architecture and the like. There is a need to develop new methods of displaying and enhancing the visual appearance of these visual arts.

### SUMMARY OF THE INVENTION

According to a first aspect of the invention there is provided a display for an image including:

a first substrate having a cyan layer of the image thereon;

a second substrate having a magenta layer of the image thereon;

a third substrate having a yellow layer of the image thereon;

a fourth substrate having a black layer of the image thereon;

the substrate layers being aligned thereby displaying the complete image.

Preferably each of the substrates are sheets of glass. Preferably each of the layers is printed directly onto the respective sheet of glass using ink. In alternative embodiments each of the layers is printed onto transparent acrylic or material and this is applied to the respective sheet of glass.

Preferably each of the sheets of glass includes an aligned mounting hole through which a mounting bolt is threaded to securely mount the layers together.

Preferably the display is rectangular having four corners and each of the sheets includes aligned mounting holes at each of the corners through which a mounting bolt is threaded to securely mount the layers together.

According to a second aspect of the invention there is provided a method for displaying an image including the steps of:

separating the image into its print colours of cyan, magenta, yellow and black;

providing a first substrate and applying a cyan layer of the image thereon;

providing a second substrate and applying a magenta layer of the image thereon;

providing a third substrate and applying a yellow layer of the image thereon;

providing a fourth substrate and applying a black layer of the image thereon; and

aligning the substrate layers together thereby displaying the complete image.

According to a third aspect of the invention there is disclosed a display for an image including:

a first substrate having a first colour layer of the image thereon;

a second substrate having a second colour layer of the image thereon;

a third substrate having a third colour layer of the image thereon;

a fourth substrate having a fourth colour layer of the image thereon;

the substrates being layered and/or aligned together thereby displaying the complete image.

Throughout this specification and claims which follow, unless the context requires otherwise, the word “comprise”, and other variations such as “comprises” and “comprising”, will be understood to imply the inclusion of a stated integer or step or group of integers or steps but not the exclusion of any other integer or step or group of integers or steps.

### BRIEF DESCRIPTION OF THE DRAWINGS

A preferred embodiment of the invention will now be described, by way of example only, with reference to the accompanying drawings in which:

FIG. 1 is a perspective view of a display according to the invention;

FIG. 2 is a side view of the display of FIG. 1;

FIG. 3A is a view of an image to be split according to the invention.

FIGS. 3B, 3C, 3D and 3E are views of the colour layers of FIG. 3A;

FIGS. 4A and 4B are a side view and front view of the display of FIG. 3.

### PREFERRED EMBODIMENT OF THE INVENTION

The preferred embodiment of the invention provides a display for an image including: a first substrate having a cyan layer of the image thereon; a second substrate having a magenta layer of the image thereon; a third substrate having a yellow layer of the image thereon; a fourth substrate having a black layer of the image thereon; wherein the substrates are layered and stacked thereby displaying the complete image. The colours cyan, magenta, yellow and black are referred herein as print colours.

In the preferred embodiment each of the substrates are sheets of glass however any suitable transparent material can be used. Each of the print colour layers is printed directly onto the respective sheet of glass using ink.

In an alternative embodiment each of the layers is printed onto transparent acrylic or other suitable material such as self adhesive vinyl and this is applied to the respective sheet of glass. In another embodiment the layers can be painted or printed directly onto a suitable substrate. It would be clear that embodiments of the invention extend to any suitable manner of accurately transferring colour layers of an image to the substrate (or glass or acrylic or suitable transparent material) and the scope of the invention is not limited to the methods described herein.

The image can be a painting, photograph, print, digitally created image or any other suitable visual image that can be broken into its colour components.

Each of the sheets of glass includes an aligned mounting hole through which a mounting bolt is threaded to securely mount the layers together. In the preferred embodiment the display is rectangular having four corners and each of the sheets includes aligned mounting holes at each of the corners through which a mounting bolt is threaded to securely mount the layers together.

The preferred embodiment of the invention uses sheets of glass having dimensions of 45 CM×65 CM however sheets of any size can be used. Larger sheets of glass can be cut by a glazier to the specified dimensions then stacked one on top of the other. Holes matching the size of the bolts used are then drilled in each of the four corners at a specified point. The bolts are then used to hold together (in correct alignment) all the glass layers once the transparent acrylic had been applied to each. This is only one way of aligning, then holding together, the separate layers to reform the image as a whole.

The display can take any suitable shape such as round, square, oval and the like and the mounting holes can be placed at appropriate points in the chosen shape.

The preferred embodiment provides a method for displaying an image including the steps of:

separating the image into its print colours of cyan, magenta, yellow and black;

providing a first substrate and applying a cyan layer of the image thereon;

providing a second substrate and applying a magenta layer of the image thereon;

providing a third substrate and applying a yellow layer of the image thereon;

providing a fourth substrate and applying a black layer of the image thereon; and

layering the substrates thereby displaying the complete image.

The preferred method of producing the different colour layers is disclosed below. When an image or picture is converted into a digital file for printing, it is commonly saved on a computer as a CMYK TIFF FILE. TIFF is an acronym for the Tagged Image File Format and is a file format for storing images, including photographs and line art and is typically used to save images or pictures of any kind or size.

TIFF remains widely accepted as a ‘photograph or image file’ standard in the printing industry. The TIFF file is most commonly used to handle device-specific colour spaces, meaning it is appropriate for CMYK printing processes and inks or variants of the CMYK printing process and inks.

Other file types typically used for images and pictures include JPEG (Joint Photographic Experts Group), RAW (raw image formats), PNG (Portable Network Graphics), GIF (Graphics Interchange Format) and BMP (Windows bitmap). The particular file type used is typically determined by the application of the image and the preferred embodiment uses the TIFF format.

Once a suitable digital image file has been obtained it is necessary to separate the file into colour layers. Using a digital image manipulation software package such as Photoshop, it is possible to ‘break up’ a single image printable file into its colour channels. In most cases those are cyan, magenta, yellow and black. Each of these colour channels are then stored as a separate image file having exactly the same dimensions and each file represents the extraction of a pure colour layer from the one individual image.

After producing the separate colour layer files each of the colour layers can be printed separately and applied separately onto glass or transparent material of exactly the same dimensions or each printed directly onto separate layers of glass or transparent material of exactly the same dimensions.

The colour layer components are then sandwiched or layered together, one on top of the other, in exact alignment and in an order appropriate for the subject matter or intention of the display. The complete image is thus re-formed or recreated, the result being a compelling visual effect which displays the full image with the unique semi-transparent 3D effect.

The preferred embodiment of the invention allows for the colour layers to be organised in any order and in the order which best suits the subject matter or the intention of the piece.

Each colour layer of an image can to be applied to a corresponding clear surface in any suitable method such as direct printing with printers ink or printing onto transparent acrylic or vinyl and then application to a corresponding transparent surface. Other embodiments of the invention extend to painting the colour layers of an image onto a transparent surface such as glass. In this embodiment an artist or ‘Photorealist’ could copy and reproduce each of the printed colour layers onto a suitable transparent surface and then assemble the display as discussed above

The four colour process will now be discussed. CMYK is a term that stands for ‘Cyan, Magenta, Yellow, and Black’ and represents the four colour printing process, employed as a fairly standard worldwide printing process.

These are the standard print colours that are used in combination to print a final whole image. Variations include a 6 colour CcMmYK process, which adds light cyan and light magenta inks to the CMYK inks. A further system is a proprietary 6 colour Hexachrome system owned by Pantone which adds orange and green to the traditional CMYK ink (CMYKOG). A display using either of these printing processes would have 6 layers as opposed to the four layers using a CMYK process.

A further method that can be used with a preferred embodiment is spot colour printing where additional individual colours are added to more accurately reproduce the colour of the original image or to add an effect such as a gloss, varnish or metallic effect. If any additional colours other than the standard CMYK are printed in order to re-create a single image, the number of transparent colour layers used to recreate that image will be increased accordingly in the final display. In other words, the number of print colour layers determines the number of glass or transparent material layers required to re-create the original image.

It would be understood that any suitable printing system can be used with embodiments of the invention. The number of colour layers used by the particular printing system will determine the number of glass coloured layers produced and layered together. For example, if using the CMYK colour system, 4 glass layers are ultimately produced and layered together to reproduce the image, in a 6 colour system 6 glass layers are used and so on. If further colour systems use additional layers of colours such as 8 or 10, then the corresponding number of glass layers are created and layered or sandwiched together.

Once the glass layers have been prepared by either printing directly onto them or by otherwise applying a coloured layer to them it is necessary to align and affix the transparent material layers for display.

The preferred method is to secure each transparent layer to the other using a bolt system. It is preferred that one bolt be applied in each corner (if the layers are rectangular or square). Any other suitable method of securing the layers can be used such as a clamping system that clamps the layers together. A clamp can be applied to each corner or the entire border or edge of the display can be clamped according to the requirements of the display. A traditional frame system or in fact any other suitable means of holding and aligning all layers together securely, can also be used for any artistic embodiment of the display.

In alternative embodiments the display is used as a component of a building—for instance a glass wall in a winery. The process of securing each pane of glass together to create the display effect involves aligning and securing the layers in a solid framework which could be a component of the building such as a window frame.

The accurate alignment of the layers on top of each other is required for the unique effect that the display creates. Accordingly it is necessary for the layers to be accurately aligned before securing the layers by any suitable manner.

The display can take any suitable shape or size. Common shapes include rectangles, squares, circles, triangles and the like but non conventional shapes can be used as desired and it would be understood that embodiments of the invention extend to any suitable or desired shape and any suitable size.

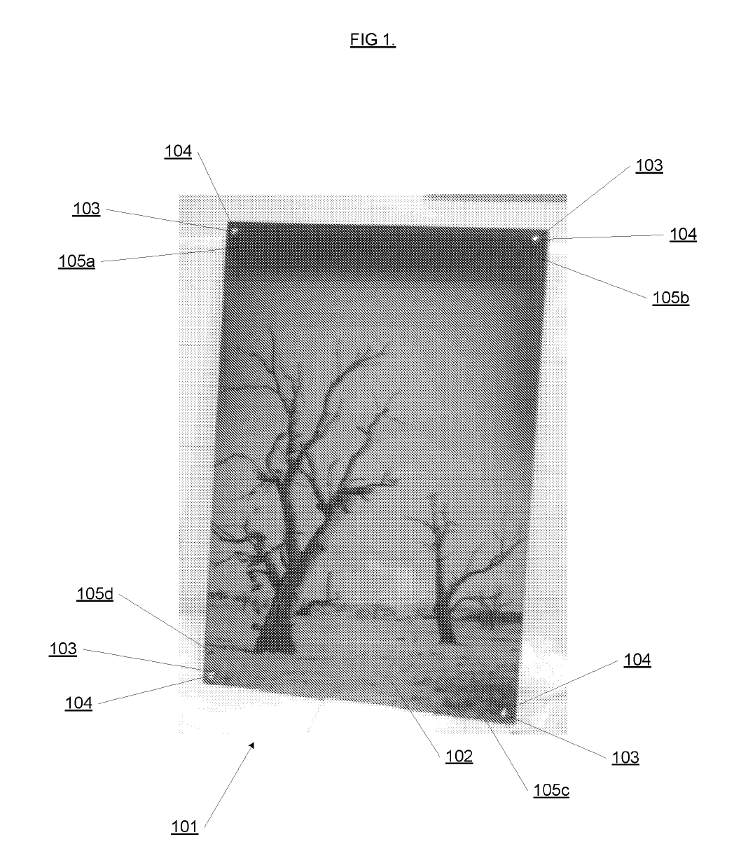

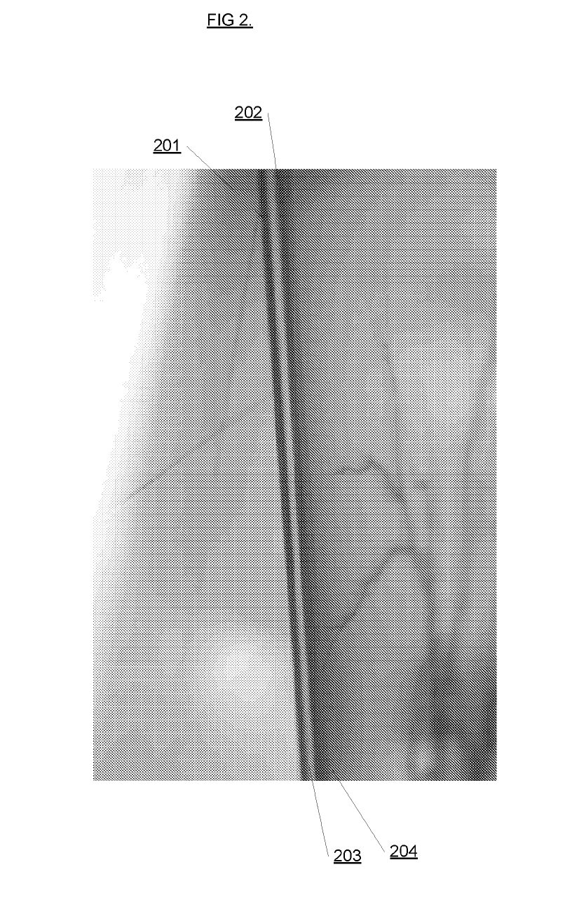

Referring to the drawings, FIGS. 1 and 2 show a display 101 for an image 102. The display includes a first glass sheet 201 having a cyan layer of the image printed thereon. The display has a second glass sheet 202 having a magenta layer of the image printed thereon, a third glass sheet 203 having a yellow layer of the image printed thereon and a fourth glass sheet 204 having a black layer of the image printed thereon. The substrates are layered thereby displaying the complete image 102. Each of the print colour layers is printed directly onto transparent self adhesive vinyl then applied in precise alignment to each respective sheet of glass.

Each of the sheets of glass includes an aligned mounting hole 103 through which a mounting bolt 104 is threaded to securely mount the layers together. Display 101 is rectangular having four corners 105 a, b, c and d and each of the sheets includes aligned mounting holes at each of the corners through which a mounting bolt is threaded to securely mount the layers together.

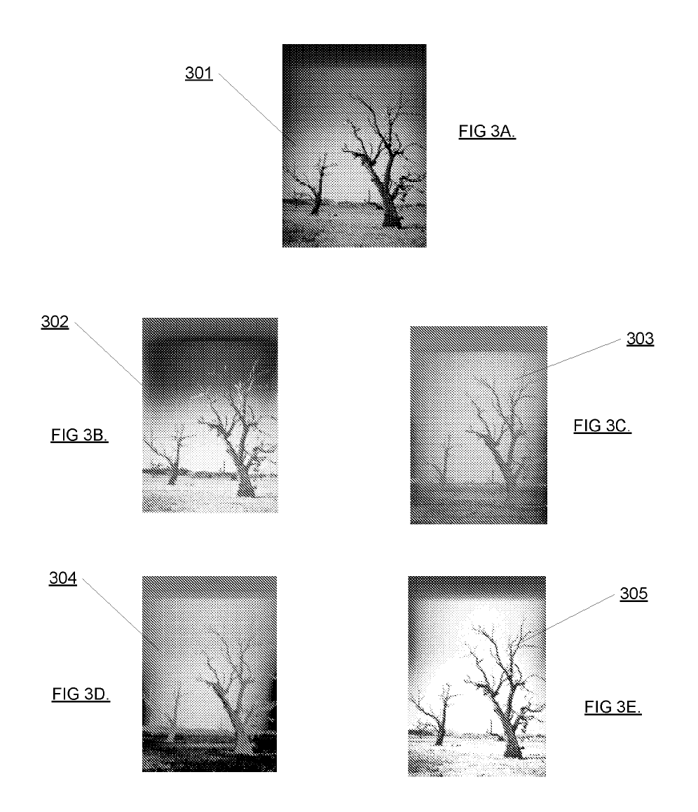

Referring to FIGS. 3a-e there is shown an image 301. Each of the print colours Cyan, Magenta, Yellow and Black of the image 301 is printed onto transparent acrylic and then applied to the surface of the glass sheets. In an alternative embodiment each colour layer would be printed directly onto each separate sheet or layer of glass. Each of the glass layers represents the entire total amount of its corresponding colour within the overall image. Sheet 302 is the cyan layer, sheet 303 is the magenta layer, sheet 304 is the yellow layer and sheet 305 is the black layer.

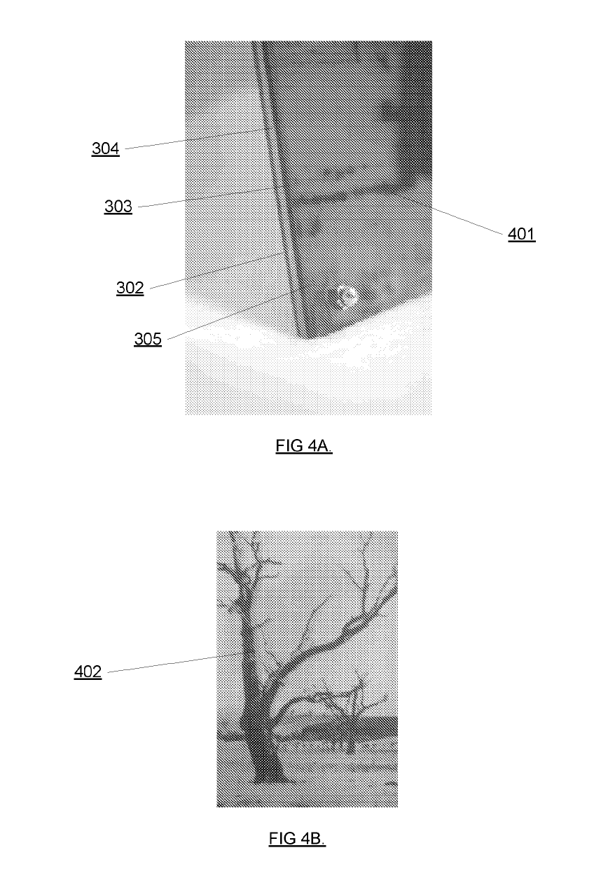

The glass colour layers are then placed on top of each other or “sandwiched” together. In the example, the cyan layer 302 is seen at the bottom, the yellow layer 304 placed on top of the cyan layer, the magenta layer 303 being placed on top of the yellow layer and the black layer 305 being placed on top of the magenta layer as shown in FIG. 4a.

It will be noted that the layers can be ordered in any suitable order of colour and that it is not necessary to order the layers as described above. The particular order can be varied according to the order best suited for a particular subject matter or intention of the image.

A viewer viewing the image front on or at an angle sees image 402 as shown in FIG. 4b which has a unique, visually attractive and semi transparent 3D look. With regard to the example images (102 and 402) it should be noted that the viewer experience is much more dynamic and striking when seen first hand and because of its nature and the way it uses available light as a display component this look is difficult if not impossible to reproduce two dimensionally. This display has both artistic and commercial appeal and application in commercial fields including industrial design, architectural design and the like.

While the preferred embodiment uses the print colours cyan, magenta, yellow and black it would be understood that any other suitable colour scheme can be used to achieve embodiments of the invention.

In another embodiment of the invention the images are moving images and a computer processor splits the image into its colour layers and displays each image on a separate display, the displays being stacked and layered to create an image with increased depth and/or dimension. The images can be analogue or digital moving images received from a digital or analogue television broadcast, play back from a VCR, DVD, Personal Video Recorder, Personal Computer or any suitable video source. The image or video can be split into its colours in real time by the processor and displayed directly onto the plurality of layered screens. Alternatively the image or movie can be pre-recorded into its colour layers and simply played back onto the plurality of layers.

There are hundreds of available computer languages that may be used to implement embodiments of the invention, among the more common being Ada; Algol; APL; awk; Basic; C; C++; Cobol; Delphi; Eiffel; Euphoria; Forth; Fortran; HTML; Icon; Java; Javascript; Lisp; Logo; Mathematica; MatLab; Miranda; Modula-2; Oberon; Pascal; Perl; PL/I; Prolog; Python; Rexx; SAS; Scheme; sed; Simula; Smalltalk; Snobol; SQL; Visual Basic; Visual C++; and XML.

Any commercial processor may be used to implement the embodiments of the invention either as a single processor, serial or parallel set of processors in the system. Examples of commercial processors include, but are not limited to Merced™, Pentium™, Pentium II™, Xeon™, Celeron™, Pentium Pro™, Efficeon™, Athlon, AMD and the like.

Display screens may be segment display screen, analogue display screens, digital display screens, CRTs, LED screens, Plasma screens, liquid crystal diode screens, and the like.

Although the invention has been described with reference to specific examples, it will be appreciated by those skilled in the art that the invention may be embodied in many other forms.

1. A display for an image comprising:
a first transparent substrate having a cyan component layer of the image thereon;
a second transparent substrate having a magenta component layer of the image thereon;
a third transparent substrate having a yellow component layer of the image thereon;
a fourth transparent substrate having a black component layer of the image thereon;
the substrate layers being aligned thereby displaying the complete image with a semi transparent dimensional appearance.

2. A display according to claim 1 wherein the substrates are sheets of glass.

3. A display according to claim 2 wherein each of the layers is printed directly onto the respective sheet of glass using ink.

4. A display according to claim 2 wherein each of the layers is printed onto a material and this material is applied to the respective sheet of glass.

5. A display according to claim 2 wherein each of the sheets of glass includes an aligned mounting hole through which a mounting bolt is threaded to securely mount the layers together.

6. A display according to claim 5 wherein the display is rectangular having four corners and each of the sheets includes aligned mounting holes at each of the corners through which a mounting bolt is threaded to securely mount the layers together.

7. A method for displaying an image comprising the steps of:
separating the image into its print colours of cyan, magenta, yellow and black;
providing a first transparent substrate and applying a cyan layer of the image thereon;
providing a second transparent substrate and applying a magenta layer of the image thereon;
providing a third transparent substrate and applying a yellow layer of the image thereon;
providing a fourth transparent substrate and applying a black layer of the image thereon; and
aligning the substrate layers together thereby displaying the complete image with a semi transparent 3 dimensional appearance.

8. A method for display for an image comprising the steps of:
providing a first transparent substrate having a first colour component layer of the image thereon;
providing a second transparent substrate having a second colour component layer of the image thereon;
providing a third transparent substrate having a third colour component layer of the image thereon;
the substrates being layered and/or aligned together thereby displaying the complete image with a semi transparent 3 dimensional appearance.

9. (canceled)

10. A method according to claim 7 wherein the substrates are transparent sheets of glass.

11. A method according to claim 10 further comprising the step of printing each of the layers directly onto the respective sheet of glass using ink.

12. A method according to claim 10 further comprising the step of printing each of the layers onto transparent acrylic or other transparent material and applying this layer to the respective sheet of glass or transparent material.

13. (canceled)

14. (canceled)

15. A method according to claim 7 wherein the transparent layers are secured in a frame.

16. A method according to claim 15 wherein the frame is a solid frame work.

17. A method according to claim 16 wherein the solid frame work is a wall.

18. A method according to claim 8 wherein each substrate is a separate computer or television display screen and the image component layers are received by the separate displays from a computer.

19. A method according to claim 18 wherein the image is a moving image.

20. A method according to claim 19 wherein the computer or television includes a processor and the computer processor splits the moving image into its colour component layers and displays each colour component of the image on each separate display.

21. A method according to claim 20 wherein the completed image has increased depth and/or dimension.

22. A method according to claim 8 wherein further comprising the step of providing a fourth transparent substrate having a fourth colour component layer of the image thereon;

23. A method according to claim 8 wherein the first colour is red, the second colour is blue and the third colour is green.
